(19) United States
(12) Patent Application Publication
(10) Pub. No.: US 2026/0328993 A1
(43) Pub. Date: Oct. 22, 2026

(54) ANTI-RESONANT HOLLOW-CORE OPTICAL FIBER WITH ARCUATE ELEMENTS ENCLOSING NESTED CAPILLARIES

(71) Applicant: CORNING INCORPORATED, CORNING, NY (US)

(72) Inventors: Paulo Clovis Dainese, Jr., Painted Post, NY (US); Ilia Andreyevich Nikulin, Leland, NC (US)

(21) Appl. No.: 19/637,128

(22) Filed: Apr. 2, 2026

Related U.S. Application Data
(60) Provisional application No. 63/790,108, filed on Apr. 17, 2025.

(51) Int. Cl. G02B 6/02

(52) U.S. Cl. CPC G02B 6/02328

(57) ABSTRACT

An anti-resonant hollow-core optical fiber that includes a cladding tube within which anti-resonant cladding elements with arcuate elements are disposed. The arcuate elements extend from the inner surface of the cladding tube to define an arcuate interior space in which one or more primary capillaries are disposed, where at least one of the primary capillaries includes a nested capillary. Outer surfaces of the arcuate elements define an effective core region with an effective core radius in which the fundamental mode of electromagnetic radiation is confined. The number, arrangement, and dimensions of the arcuate elements, primary capillaries, and nested capillaries are designed to (1) provide low confinement loss of the fundamental mode in the effective core region; (2) provide strong coupling of higher order modes to modes of the anti-resonant cladding elements; (3) avoid sharp peaks in confinement loss of the fundamental mode over a wide wavelength range.

This application claims the benefit of priority to U.S. Provisional Patent Application Ser. No. 63/790,108 filed on Apr. 17, 2025, the content of which is relied upon and incorporated herein by reference in its entirety.

### TECHNICAL FIELD

The present disclosure pertains to anti-resonant hollow-core optical fibers and, more particularly, to anti-resonant hollow-core optical fibers that include a plurality of anti-resonant cladding elements, each of which include an arcuate element with an arcuate interior in which a primary capillary comprising a nested capillary is disposed.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow-core optical fibers are under development. Hollow-core optical fibers mitigate attenuation of optical signals and provide further advantages such as low non-linearity, low dispersion, and low latency. Hollow-core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow-core optical fibers relies upon anti-resonance between the core and the cladding to confine the electromagnetic radiation within the core and to prevent leakage of the fundamental mode into the cladding. Such optical fibers are sometimes referred to as anti-resonant hollow-core optical fibers, or AR-HCFs for short. With AR-HCFs, a central hollow-core is surrounded by anti-resonant cladding elements contained in a cladding tube. The anti-resonant cladding elements are made of relatively thin glass to realize an anti-resonant effect that confines the fundamental mode to the core. The greater the anti-resonant effect of the cladding elements, the greater the confinement of the fundamental within the core, and thus the lower the confinement loss for the fundamental mode.

Engineering and design of anti-resonant cladding elements to achieve lower confinement loss for the fundamental mode across all wavelengths of a desired operational wavelength ranges is an evolving field of endeavor. In addition to low confinement loss for the fundamental mode, it is desirable to maintain single moded transmission of the fundamental mode in the hollow-core optical fiber. Higher order modes (HOMs) are problematic and it is desirable to eliminate them. One strategy for eliminating higher order modes is to couple them to modes supported by the cladding elements. Such coupling removes higher order modes from the core and leads to transmission of a purer fundamental mode. Designing cladding elements that efficiently remove higher order modes remains challenging and pure single mode transmission is difficult to achieve in hollow-core optical fibers.

In addition, there is a practical problem in that anti-resonant hollow-core fibers are difficult to manufacture at large scale. The anti-resonant cladding elements must satisfy exacting structural requirements to perform efficiently and are highly sensitive to dimensional fluctuations expected from manufacturing variability. For example, in preferred designs, anti-resonant cladding elements are designed not to contact each other because points of contact represent nodes that lead to loss of the fundamental mode. Due to manufacturing imprecision in current processes, anti-resonant elements designed to be non-contacting tend to contact each other during draw and lead to anti-resonant hollow-core optical fiber that exhibit peaks (sharp increases) in confinement loss as a function of wavelength. Inaccuracies or variability in the azimuthal position of the anti-resonant cladding elements relative to each other also comprises the confinement loss.

There is accordingly a need for new designs of hollow-core optical fibers that provide greater stability in the dimensions and position of anti-resonant cladding elements, low confinement loss of the fundamental mode, and high extinction of higher order modes.

### SUMMARY

The present disclosure addresses those problems, and others, with an anti-resonant hollow-core optical fiber that includes a cladding tube within which anti-resonant cladding elements with arcuate elements are disposed. The arcuate elements extend from the inner surface of the cladding tube to define an arcuate interior space in which one or more primary capillaries are disposed where at least one of the primary capillaries includes a nested capillary. Outer surfaces of the arcuate elements define an effective core region with an effective core radius in which the fundamental mode of electromagnetic radiation is confined. The number, arrangement, and dimensions of the arcuate elements, primary capillaries, and nested capillaries are designed to (1) provide low confinement loss of the fundamental mode in the effective core region; (2) provide strong coupling of higher order modes to modes of the anti-resonant cladding elements; (3) avoid sharp peaks in confinement loss of the fundamental mode over a wide wavelength range.

According to a first aspect of the present disclosure, an anti-resonant hollow-core optical fiber comprises:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis;
a plurality of arcuate elements extending longitudinally from the first fiber end to the second fiber end, each of the plurality of arcuate elements (a) extending from a first point on the cladding inner surface to a second point on the cladding inner surface, and (b) comprising (i) an arcuate outer surface having an arcuate outer radius facing the fiber longitudinal axis and (ii) an arcuate inner surface facing the cladding inner surface, the arcuate inner surface defining an arcuate interior;
a plurality of first primary capillaries arranged azimuthally around the fiber longitudinal axis, each of the plurality of first primary capillaries (a) contacting the cladding inner surface, (b) disposed within the arcuate interior of a different one of the arcuate elements, and (c) comprising (i) a first primary longitudinal axis that is parallel to the fiber longitudinal axis, (ii) a first primary outer surface at a first primary outer radius from the first primary longitudinal axis, and (iii) a first primary inner surface at a first primary inner radius from the first primary longitudinal axis, the first primary inner surface defining a first primary interior;
a plurality of nested capillaries extending longitudinally from the first fiber end to the second fiber end, each of the plurality of nested capillaries (a) disposed within the first primary interior of a different one of the plurality of first primary capillaries and (b) comprising (i) a capillary axis that is parallel to the fiber longitudinal axis; (ii) a nested outer surface at a nested outer radius from the capillary axis, and (iii) a nested inner surface at a nested inner radius from the capillary axis, the nested inner surface defining a nested interior; and an effective core region tangential to the arcuate outer surface of the plurality of arcuate elements at an effective core radius from the fiber longitudinal axis, the plurality of arcuate elements disposed radially outward of the effective core region, the effective core region configured to confine electromagnetic radiation.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow-core optical fiber of the present disclosure, illustrating a cladding tube and anti-resonant cladding elements with arcuate elements, primary capillaries, and nested capillaries disposed within the cladding tube, according to one embodiment;

FIG. 2A is a cross-sectional view of the anti-resonant hollow-core optical fiber taken through line II-II of FIG. 1;

FIG. 2B is a cross-sectional view of the primary capillary and nested capillaries of an embodiment of the anti-resonant cladding elements of an anti-resonant hollow-core optical fiber;

FIG. 2C is a cross-sectional view showing an arcuate element of an anti-resonant cladding element an anti-resonant hollow-core optical fiber;

FIG. 3A is a cross-sectional view of an anti-resonant hollow-core in which each arcuate element encloses three primary capillaries, each of which includes a nested capillary, according to an embodiment;

FIG. 3B is a cross-sectional view of an anti-resonant hollow-core in which each arcuate element encloses three primary capillaries, only one of which includes a nested capillary, according to an embodiment;

FIG. 4 depicts a method of manufacturing an anti-resonant hollow-core optical fiber, according to an embodiment;

FIG. 5 is a schematic diagram of the drawing step, illustrating the anti-resonant hollow-core optical fiber being drawn from the optical fiber preform;

FIG. 6 shows the spatial distribution of electric field strength of the fundamental mode at 1550 nm in a representative anti-resonant hollow-core optical fiber.

FIG. 7 shows confinement loss for the fundamental mode, confinement loss for the higher order modes, and surface scattering loss as a function of wavelength in a representative anti-resonant hollow-core optical fiber.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

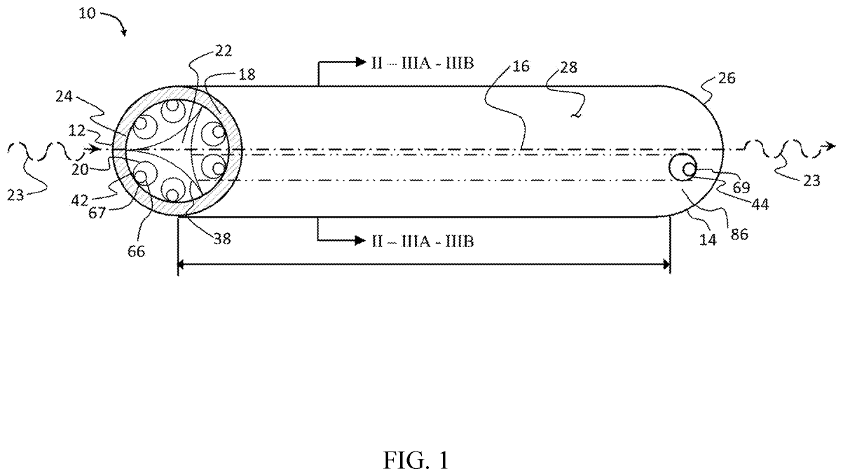

Referring to FIGS. 1-3B, an anti-resonant hollow-core optical fiber 10 includes a first fiber end 12, a second fiber end 14, a fiber longitudinal axis 16, a cladding tube 18, a plurality of primary capillaries 20, a plurality of nested capillaries 66, a plurality of arcuate elements 38, and an effective core region 22. The fiber longitudinal axis 16 extends from the first fiber end 12 to the second fiber end 14. In use, electromagnetic radiation 23 enters into the first fiber end 12, transmits predominantly within the effective core region 22, and exits the second fiber end 14.

The cladding tube 18 likewise extends, azimuthally around the fiber longitudinal axis 16, from the first fiber end 12 to the second fiber end 14. The cladding tube 18 includes a first cladding end 24 and a second cladding end 26. The first cladding end 24 is proximate, and may at least partially define, the first fiber end 12. The second cladding end 26 is proximate, and may at least partially define, the second fiber end 14.

The cladding tube 18 further includes a cladding outer surface 28 and a cladding inner surface 30. The cladding outer surface 28 is at a cladding outer radius 32 from the fiber longitudinal axis 16. The cladding inner surface 30 is at a cladding inner radius 34 from the fiber longitudinal axis 16. The cladding inner surface 30 defines a cladding interior 36.

Cladding inner radius 34 is greater than or equal to 40 μm, or greater than or equal to 45 μm, or greater than or equal to 50 μm, or greater than or equal to 55 μm, or greater than or equal to 60 μm, or greater than or equal to 65 μm, or less than or equal to 70 μm, or less than or equal to 65 μm, or less than or equal to 60 μm, or less than or equal to 55 μm, or less than or equal to 50 μm, or in the range from 40 μm to 70 μm, or in the range from 45 μm to 65 μm, or in the range from 47 μm to 63 μm, or in the range from 50 μm to 60 μm.

Cladding outer radius 32 defines the glass boundary of the anti-resonant hollow-core optical fiber 10. Cladding outer radius 32 is greater than or equal to 50 μm, or greater than or equal to 55 μm, or greater than or equal to 60 μm, or greater than or equal to 65 μm, or greater than or equal to 70 μm, or greater than or equal to 75 μm, or less than or equal to 80 μm, or less than or equal to 75 μm, or less than or equal to 70 μm, or less than or equal to 65 μm, or less than or equal to 60 μm, or in the range from 50 μm to 80 μm, or in the range from 55 μm to 75 μm, or in the range from 57 μm to 70 μm, or in the range from 60 μm to 65 μm, or in the range from 61 μm to 64 μm.

The plurality of primary capillaries 20 is disposed within the cladding interior 36. The plurality of primary capillaries 20 is arranged azimuthally around the fiber longitudinal axis 16. The arrangement of primary capillaries 20 is preferably such that none of the primary capillaries 20 contacts another of the primary capillaries 20 so that a gap is present between adjacent ones of the primary capillaries 20. Each of the plurality of primary capillaries 20 contacts cladding inner surface 30 and is attached thereto. Each of the plurality of primary capillaries 20 includes a capillary first end 42 and a capillary second end 44. The capillary first end 42 is proximate, and may at least partially define, the first fiber end 12. The capillary second end 44 is proximate, and may at least partially define, the second fiber end 14.

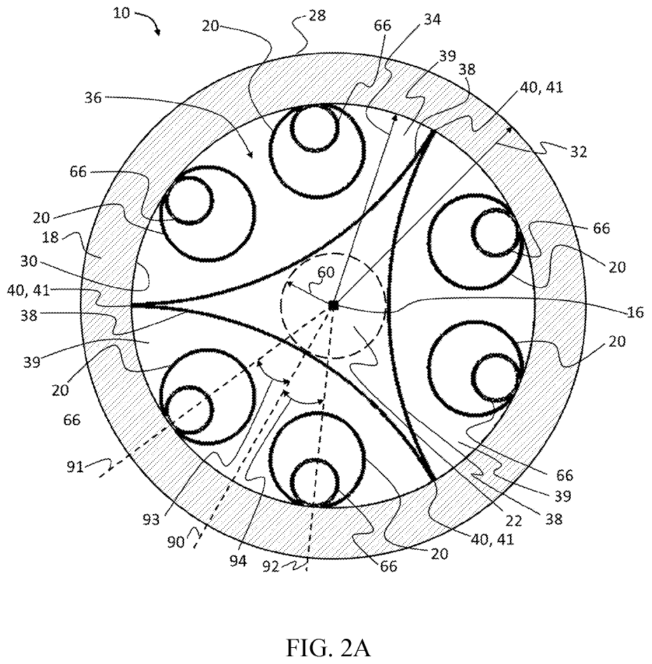

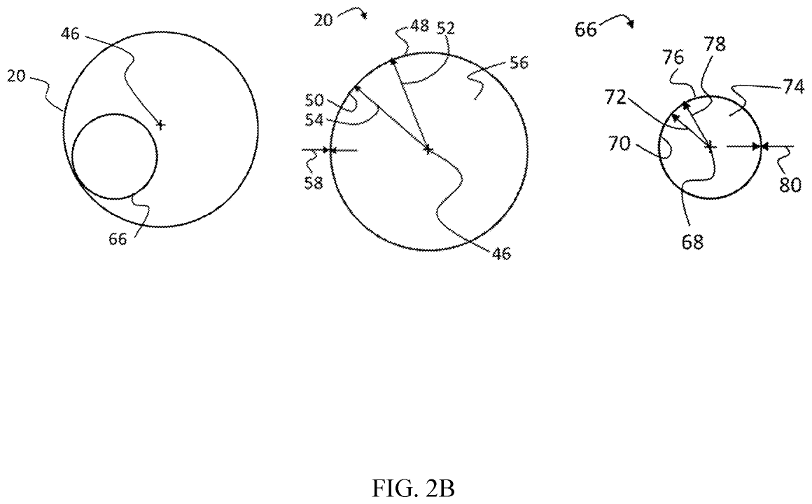

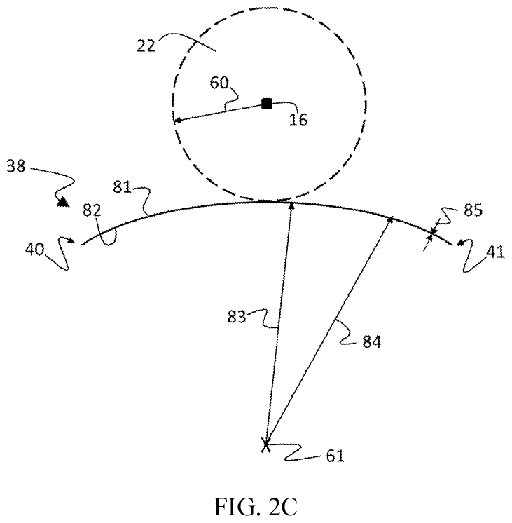

Each of the plurality of primary capillaries 20 further includes a primary longitudinal axis 46 that is parallel to the fiber longitudinal axis 16 (FIG. 2B). In addition, each of the plurality of primary capillaries 20 further includes a primary outer surface 48 and a primary inner surface 50. The primary outer surface 48 is at a primary outer radius 52 from the primary longitudinal axis 46. The primary inner surface 50 is at a primary inner radius 54 from the primary longitudinal axis 46. The difference between the primary outer radius 52 and the primary inner radius 54 is the thickness 58. The primary inner surface 50 defines a primary interior 56.

In embodiments, the primary outer radius 52 is greater than or equal to 5 μm, or greater than or equal to 10 μm, or greater than or equal to 15 μm, or greater than or equal to 20 μm, or greater than or equal to 25 μm, or less than or equal to 30 μm, or less than or equal to 25 μm, or less than or equal to 20 μm, or less than or equal to 15 μm, or in the range from 5 μm to 30 μm, or in the range from 7 μm to 25 μm, or in the range from 8 μm to 20 μm, or in the range from 9 μm to 18 μm, or in the range from 10 μm to 16 μm, or in the range from 11 μm to 15 μm. The primary outer radius 52 of the different ones of the primary capillaries 20 may be the same or different.

Each of the plurality of primary capillaries 20 further includes a primary thickness 58. The primary thickness 58 is the distance measured radially from the primary longitudinal axis 46 between the primary inner surface 50 and the primary outer surface 48. In embodiments, the primary thickness 58 is within a range of from 250 nm to 1500 nm. For example, the primary thickness 58 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 400 nm to 600 nm, from 500 nm to 850 nm, from 700 nm to 1400 nm, from 800 nm to 1300 nm, and so on). In embodiments, the primary thickness 58 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the wavelength of electromagnetic radiation 23, and n is the refractive index of the primary capillaries. The primary thickness 58 of the different ones of the primary capillaries 20 may be the same or different.

In embodiments, the anti-resonant hollow-core optical fiber 10 further includes a plurality of nested capillaries 66. The plurality of nested capillaries 66 extends longitudinally within the cladding tube 18 from the first fiber end 12 to the second fiber end 14. Each of the plurality of nested capillaries 66 includes an end 67 (see FIG. 1) disposed proximate the first cladding end 24 and can at least partially define the first fiber end 12. Each of the nested capillaries 66 includes another end 69 disposed proximate the second cladding end 26 and can at least partially define the second fiber end 14.

Each of the nested capillaries 66 is disposed within the primary interior 56 of a different one of the plurality of primary capillaries 20. Each of the nested capillaries 66 includes a capillary axis 68 (FIG. 2B). The capillary axis 68 is parallel to both the fiber longitudinal axis 16 and the primary longitudinal axis 46. Each of the nested capillaries 66 includes a nested inner surface 70 at a nested inner radius 72 from the capillary axis 68. The nested inner surface 70 defines a nested interior 74.

Each of the nested capillaries 66 further includes a nested outer surface 76 at a nested outer radius 78 from the capillary axis 68. In embodiments, the nested outer radius 78 is greater than or equal to 4 μm, or greater than or equal to 5 μm, or greater than or equal to 6 μm, or greater than or equal to 7 μm, or greater than or equal to 8 μm, or greater than or equal to 9 μm, or greater than or equal to 10 μm, or in the range from 4 μm to 12 μm, or in the range from 5 μm to 10 μm, or in the range from 6 μm to 9 μm. The nested outer radius 78 of the different ones of the nested capillaries may be the same or different.

Each of the nested capillaries 66 further includes a nested thickness 80. The nested thickness 80 is the distance measured radially from the capillary axis 68 between the nested inner surface 70 and the nested outer surface 76. In embodiments, the nested thickness 80 is within a range of from 250 nm to 1500 nm. For example, the nested thickness 80 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the nested thickness 80 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the wavelength of electromagnetic radiation 23, and n is the refractive index of the nested capillaries 66. The nested thickness 80 of the different ones of the nested capillaries 66 may be the same or different. The nested thickness 80 and the primary thickness 58 may be the same or different.

The plurality of arcuate elements 38 (FIGS. 2A and 2C) is disposed within the cladding interior 36. The plurality of arcuate elements 38 is arranged azimuthally around the fiber longitudinal axis 16. Each of the plurality of arcuate elements 38 contacts cladding inner surface 30 and is attached thereto at points 40 and 41. Each of the plurality of arcuate elements 38 extends from a first point 40 on cladding inner surface 30 to a second point 41 on cladding inner surface 30. The arrangement of arcuate elements 38 is preferably such that adjacent ones of arcuate elements 38 contact so that adjacent ones of the plurality of arcuate elements 38 share a common point of contact with cladding inner surface 30. In the embodiment of FIG. 2A, points 40 and 41 of adjacent arcuate elements 38 are coincident.

Each of the plurality of arcuate elements 38 includes an arcuate first end and an arcuate second end. The arcuate first end is proximate, and may at least partially define, the first fiber end 12. The arcuate second end 44 is proximate, and may at least partially define, the second fiber end 14.

Each of the plurality of arcuate elements further includes an arcuate longitudinal axis 61 that is parallel to the fiber longitudinal axis 16 (FIG. 2C). In addition, each of the plurality of arcuate elements 38 further includes an arcuate outer surface 81 facing the fiber longitudinal axis 16 and an arcuate inner surface 82 facing cladding inner surface 30. The arcuate outer surface 81 is at an arcuate outer radius 84 from the arcuate longitudinal axis 61. The arcuate inner surface 82 is at an arcuate inner radius 83 from the arcuate longitudinal axis 61. The arcuate inner surface 82 defines an arcuate interior 39. Arcuate interior 39 extends between arcuate inner surface 82 and cladding inner surface 30. At least one of the plurality of first primary capillaries 20 and one of the plurality of nested capillaries 66 is disposed within arcuate interior 39 of each arcuate element 38. Arcuate element 38 may be said to enclose at least one of the plurality of first primary capillaries 20 and at least one of the plurality of nested capillaries.

The arcuate outer radius 84 varies depending on the number of arcuate elements 38 and the cladding inner radius 34. The larger is the number of arcuate elements 38 and the smaller is the cladding inner radius 34, the smaller is the arcuate outer radius 84. In various embodiments, the arcuate outer radius 84 is greater than or equal to 60 μm, or greater than or equal to 70 μm, or greater than or equal to 80 μm, or greater than or equal to 90 μm, or greater than or equal to 100 μm, or greater than or equal to 110 μm, or less than or equal to 120 μm, or less than or equal to 110 μm, or less than or equal to 100 μm, or less than or equal to 90 μm, or less than or equal to 80 μm, or in the range from 60 μm to 120 μm, or in the range from 70 μm to 110 μm, or in the range from 80 μm to 100 μm. The arcuate outer radius 84 of the different ones of the arcuate elements 38 may be the same or different.

In some embodiments, the ratio of arcuate outer radius 84 to cladding inner radius 34 is greater than or equal to 1.4, or greater than or equal to 1.5, or greater than or equal to 1.6, or greater than or equal to 1.7, or greater than or equal to 1.8, or greater than or equal to 1.9, or greater than or equal to 2.0, or greater than or equal to 2.1, or less than or equal to 2.2, or less than o or less than or equal to 2.1, or equal to 2.0, or less than or equal to 1.9, or less than or equal to 1.8, or less than or equal to 1.7, or less than or equal to 1.6, or in the range from 1.4 to 2.2, or in the range from 1.5 to 2.1, or in the range from 1.6 to 2.0, or in the range from 1.7 to 1.9.

In one embodiment, arcuate elements 38 are arc segments of a circle. In other embodiments, arcuate elements 38 are curved with a shape that differs from an arc segment of a circle. Such curved shapes include, for example, arc segments of an ellipse. In embodiments in which arcuate elements 38 are curved with a shape that differs from an arc segment of a circle, the arcuate inner radius 83 and arcuate outer radius 84 correspond to the radii of a best fit (as defined by the method of least squares) circular arc segment that extends between points 40 and 41 that define the arcuate element 38.

Each of the arcuate elements 38 further includes an arcuate thickness 85. The difference between the arcuate outer radius 84 and the arcuate inner radius 83 is the arcuate thickness 85. In embodiments, the arcuate thickness 85 is within a range of from 250 nm to 1500 nm. For example, the first nested thickness 80 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the arcuate thickness 85 is within ±30%, ±25%, ±20%, ±15%, ±10%, or ±5% of a calculated thickness t as defined by the equation

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the wavelength of electromagnetic radiation 23, and n is the refractive index of the arcuate element 38. The arcuate thickness 85 of the different ones of the arcuate element 38 may be the same or different. The arcuate thickness 85 and nested thickness 80 may be the same or different. The arcuate thickness 85 and the primary thickness 58 may be the same or different.

The number of arcuate elements 38 is greater than or equal to three, or greater than or equal to four, or greater than or equal to five, or greater than or equal to six, or in the range from three to eight, or in the range from three to seven, or in the range from three to six, or in the range from three to five, or in the range from three to four, or exactly three, or exactly four, or exactly five, or exactly six.

The number of primary capillaries 20 disposed within arcuate interior 39 of each of the plurality of arcuate elements 38 is greater than or equal to one, or greater than or equal to two, or greater than or equal to three, or greater than or equal to four, or in the range from one to four, or in the range from one to three, or in the range from two to three, or exactly one, or exactly two, or exactly three, or exactly four.

At least one of the primary capillaries 20 disposed within arcuate interior 39 of each of the plurality of arcuate elements 38 includes a nested capillary 66. In some embodiments, each primary capillary 20 disposed within arcuate interior 39 of each of the plurality of arcuate elements 38 includes a nested capillary 66. In some embodiments, at least one of the primary capillaries 20 disposed within arcuate interior 39 of each of the plurality of arcuate elements 38 includes a nested capillary 66 and at least one of the primary capillaries 20 disposed within arcuate interior 39 of each of the plurality of arcuate elements 38 does not include a nested capillary 66. The number of nested capillaries 66 disposed within the primary interior 56 of any one of the plurality of primary capillaries 20 is zero, one, or two.

An arcuate element 38 and the set of primary capillaries and nested capillaries enclosed by it in arcuate interior 39 is referred to herein as an anti-resonant cladding element. The set of all anti-resonant cladding elements of an anti-resonant hollow-core optical fiber 10 is referred to herein as the anti-resonant cladding of the anti-resonant hollow-core optical fiber. The number of anti-resonant cladding elements is equal to the number of arcuate elements 38.

FIG. 2A shows a radial line 90 extending orthogonal to fiber longitudinal axis 16 that bisects an arcuate element 38 and extends into arcuate interior 39 between a pair of adjacent primary capillaries 20. Also shown in FIG. 2A are radial lines 91 and 92 extending orthogonal to fiber longitudinal axis 16 that bisect respective ones of the pair of adjacent primary capillaries 20. Radial line 91 defines a positioning angle 94 relative to radial line 90. Radial line 92 defines a positioning angle 95 relative to radial line 90. Positioning angles 94 and 95 are indicators of the positions of the primary capillaries 20 in arcuate interior 39. The positioning angles 94 and 95 are the same or different. In a preferred embodiment positioning angles 94 and 95 are the same. In another preferred embodiment, positioning angles 94 and 95 are configured such that adjacent ones of primary capillaries 20 are not in contact with each other and not in contact with arcuate element 38. The positioning angles 94 and 95 are greater than or equal to 10°, or greater than or equal to 15°, or greater than or equal to 20°, or greater than or equal to 25°, or greater than or equal to 30°, or less than or equal to 40°, or less than or equal to 35°, or less than or equal to 30°, or less than or equal to 25°, or in the range from 10° to 40°, or in the range from 15° to 35°, or in the range from 20° to 30°.

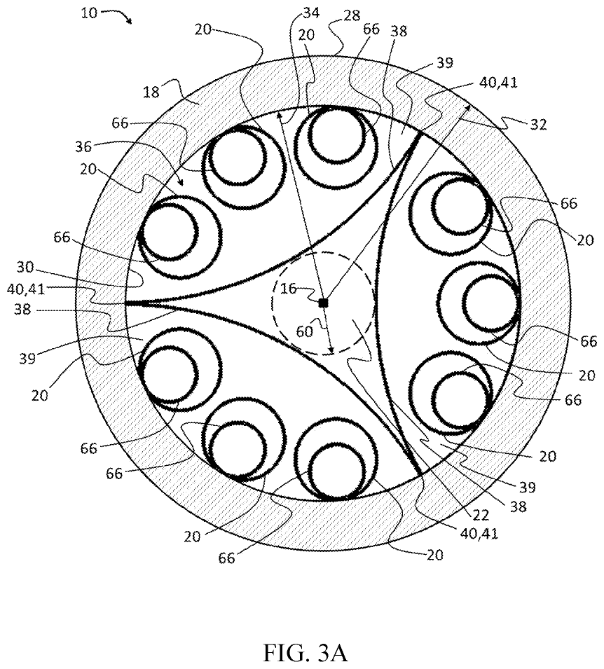

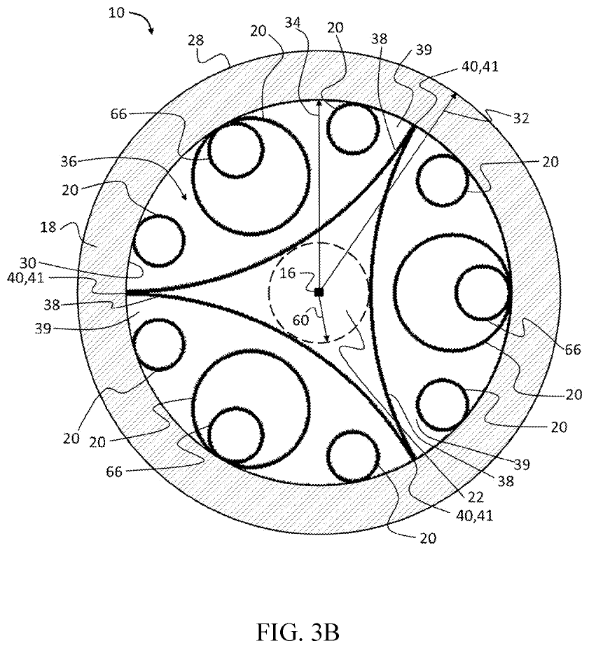

FIGS. 3A and 3B show alternate embodiments of anti-resonant hollow-core optical fiber 10. In the embodiment of FIG. 3A, each arcuate interior 39 encloses three primary capillaries 20, each of which includes a nested capillary 66. Stated alternatively, in the embodiment of FIG. 3A, three primary capillaries 20, each of which includes a nested capillary 66, are disposed in each arcuate interior 39. In the embodiment of FIG. 3B, each arcuate interior 39 encloses three primary capillaries 20, only one of which includes a nested capillary 66. Stated alternatively, in the embodiment of FIG. 3B, three primary capillaries 20, only one of which includes a nested capillary 66, are disposed in each arcuate interior 39.

The effective core region 22 is within the cladding interior 36. the effective core region 22 is tangential to the arcuate outer surface 81 of the plurality of arcuate elements 38 at an effective core radius 60 from the fiber longitudinal axis 16, the plurality of arcuate elements disposed radially outward of the effective core region. The effective core region 22 extends between the first fiber end 12 and the second fiber end 14. The plurality of primary capillaries 20 and plurality of nested capillaries 66 are disposed radially outward of the effective core region 22.

In embodiments, the effective core radius 60 is greater than or equal to 15 μm, or greater than or equal to 20 μm, or greater than or equal to 25 μm, or greater than or equal to 30 μm, or greater than or equal to 35 μm, or greater than or equal to 40 μm, or less than or equal to 50 μm, or less than or equal to 45 μm, or less than or equal to 40 μm, or less than or equal to 35 μm, or less than or equal to 30 μm, or less than or equal to 25 μm, or in the range from 15 μm to 50 μm, or in the range from 20 μm to 45 μm, or in the range from 22 μm to 40 μm, or in the range from 25 μm to 35 μm.

The number, dimensions, and positioning of the arcuate elements 38, primary capillaries 20, and nested capillaries 66 disclosed herein for the anti-resonant hollow-core optical fiber 10 are designed to minimize confinement loss of the fundamental mode and to suppress higher order modes of electromagnetic radiation 23 propagating in anti-resonant hollow-core optical fiber 10. The greater the confinement loss of higher order modes, the better the signal quality of the fundamental mode.

The designs also minimize coupling of the fundamental mode to dielectric modes supported by the anti-resonant cladding. Coupling of the fundamental mode to dielectric cladding modes is undesirable because it leads to sharp, high-loss peaks in the confinement loss spectrum of the anti-resonant hollow-core optical fiber 10. The prevailing view in the art has been that elimination of the sharp high-loss peaks in the confinement loss spectrum requires a lack of contact between the anti-resonant cladding elements. The designs disclosed herein, however, are able to minimize coupling of the fundamental mode with dielectric cladding modes even though adjacent arcuate elements 38 of the anti-resonant cladding elements are in contact. Contact of the arcuate elements 38 may improve the stability of the internal structure of the anti-resonant hollow-core optical fiber during the draw process.

In embodiments, the anti-resonant hollow-core optical fiber 10 exhibits a confinement loss for the fundamental mode of electromagnetic radiation 23, throughout an entirety of a wavelength range of from 1500 nm to 1600 nm, that is less than or equal to 0.30 dB/km. For example, the confinement loss that the anti-resonant hollow-core optical fiber 10 exhibits for the fundamental mode of electromagnetic radiation 23 at each wavelength in the wavelength range from 1500 nm to 1600 nm is less than or equal to 0.30 dB/km, or less than or equal to 0.25 dB/km, or less than or equal to 0.20 dB/km, or less than or equal to 0.15 dB/km, or less than or equal to 0.10 dB/km, or less than or equal to 0.05 dB/km, or in a range from 0.01 dB/km to 0.30 dB/km, or in a range from 0.01 dB/km to 0.25 dB/km, or in a range from 0.01 dB/km to 0.20 dB/km, or in a range from 0.01 dB/km to 0.15 dB/km, or in a range from 0.01 dB/km to 0.10 dB/km, or in a range from 0.01 dB/km to 0.05 dB/km.

In embodiments, the anti-resonant hollow-core optical fiber 10 exhibits a confinement loss for the fundamental mode of electromagnetic radiation 23, throughout an entirety of a wavelength range of from 1400 nm to 1700 nm, that is less than or equal to 0.30 dB/km. For example, the confinement loss that the anti-resonant hollow-core optical fiber 10 exhibits for the fundamental mode of electromagnetic radiation 23 at each wavelength in the wavelength range from 1400 nm to 1700 nm is less than or equal to 0.30 dB/km, or less than or equal to 0.25 dB/km, or less than or equal to 0.20 dB/km, or less than or equal to 0.15 dB/km, or less than or equal to 0.10 dB/km, or less than or equal to 0.05 dB/km, or in a range from 0.01 dB/km to 0.30 dB/km, or in a range from 0.01 dB/km to 0.25 dB/km, or in a range from 0.01 dB/km to 0.20 dB/km, or in a range from 0.01 dB/km to 0.15 dB/km, or in a range from 0.01 dB/km to 0.10 dB/km, or in a range from 0.01 dB/km to 0.05 dB/km.

In embodiments, the anti-resonant hollow-core optical fiber 10 exhibits a confinement loss for the higher order modes of electromagnetic radiation 23, throughout an entirety of a wavelength range of from 1500 nm to 1600 nm, that is greater than or equal to 10 dB/km. For example, the confinement loss that the anti-resonant hollow-core optical fiber 10 exhibits for the higher order modes of electromagnetic radiation 23 at each wavelength in the wavelength range from 1500 nm to 1600 nm is greater than or equal to 10 dB/km, or greater than or equal to 20 dB/km, or greater than or equal to 30 dB/km, or greater than or equal to 40 dB/km, or greater than or equal to 50 dB/km, or greater than or equal to 60 dB/km, or in a range from 10 dB/km to 100 dB/km, or in a range from 20 dB/km to 80 dB/km, or in a range from 30 dB/km to 70 dB/km.

In embodiments, the anti-resonant hollow-core optical fiber 10 exhibits a confinement loss for the higher order modes of electromagnetic radiation 23, throughout an entirety of a wavelength range of from 1400 nm to 1700 nm, that is greater than or equal to 10 dB/km. For example, the confinement loss that the anti-resonant hollow-core optical fiber 10 exhibits for the higher order modes of electromagnetic radiation 23 at each wavelength in the wavelength range from 1400 nm to 1700 nm is greater than or equal to 10 dB/km, or greater than or equal to 20 dB/km, or greater than or equal to 30 dB/km, or greater than or equal to 40 dB/km, or greater than or equal to 50 dB/km, or greater than or equal to 60 dB/km, or in a range from 10 dB/km to 100 dB/km, or in a range from 20 dB/km to 80 dB/km, or in a range from 30 dB/km to 70 dB/km.

The anti-resonant hollow-core optical fiber 10 exhibits relatively low confinement loss for the fundamental mode of the electromagnetic radiation 23 within and throughout the wavelength range from 1500 nm to 1600 nm, or the wavelength range from 1400 nm to 1700 nm. The low confinement loss within such wavelength ranges is desirable because 1550 nm is a common target operating wavelength. The low confinement loss was surprising because the contact between adjacent ones of the plurality of arcuate elements 38 constitute nodes, which are generally understood in the prior art to increase confinement loss. Without wishing to be bound by theory, it is theorized that the presence of nodes induces coupling between the fundamental mode in effective core region 22 and the dielectric modes within the anti-resonant cladding elements, which themselves leak into the cladding tube 18. The designs described herein of the anti-resonant hollow-core optical fiber 10 reduce such coupling by locating the nodes at positions far removed from the effective core region 22. The confinement loss of the fundamental mode can be further reduced though inclusion of nested capillaries and/or multiple primary capillaries in each of the arcuate interiors 39. The designs also increase the confinement loss for the higher order modes, which is beneficial for achieving single mode operations in an antiresonant hollow-core optical fiber.

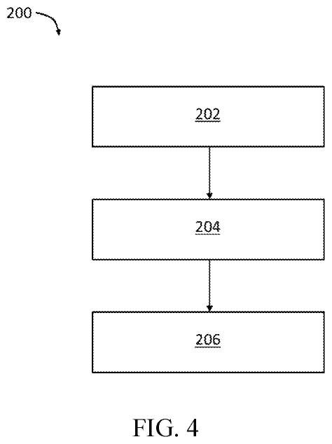

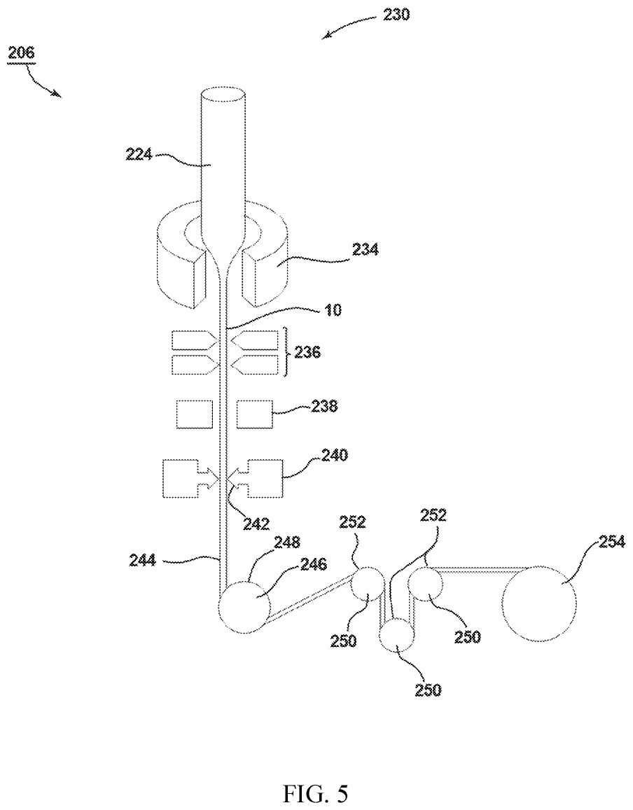

Referring now to FIG. 4, a method 200 of manufacturing the anti-resonant hollow-core optical fiber 10 is described herein. The method 200 includes at least a preform assembly step 202, a preform fusing step 204, and a drawing step 206. In some embodiments, the method includes a redraw step and/or an overclad formation step. It is noted that the internal structure of the glass portion of the anti-resonant hollow-core optical fiber 10 is a scaled down version of the internal structure of the preform 224 (FIG. 5) used in the draw of anti-resonant hollow-core optical fiber 10.

In the preform assembly step, the preform components are arranged and assembled in accordance with the design of the anti-resonant hollow-core optical fiber 10. Preform components are fabricated from glass. Preferred glasses are silica glass or doped or modified variations of silica glass (e.g., F-doped silica glass, Cl-doped silica glass, alkali- or alkaline earth modified silica glass). Preform components include counterparts to the cladding tube 18, primary capillaries 20, nested capillaries 66, and arcuate elements 38 of the anti-resonant hollow-core optical fiber. The preform components include a preform cladding tube, preform primary capillaries, preform nested capillaries, and preform arcuate elements. The preform components are scaled up versions of corresponding components of the anti-resonant hollow-core optical fiber. The preform cladding tube is a large glass tube with an internal cavity into which the desired number of preform arcuate elements, preform primary capillaries, and preform nested capillaries are inserted and arranged according to the intended design of the anti-resonant hollow-core optical fiber 10. The preform primary capillaries are glass tubes having a smaller diameter than the preform cladding tube. The preform nested capillaries are glass tubes having a smaller diameter than the preform primary capillaries. The preform nested capillaries are inserted into the preform primary capillaries. The preform arcuate elements are curved sheets of glass. Heating and softening techniques known in the art can be used to form curved glass from planar sheets at various bend radii. The preform arcuate elements are inserted into the preform cladding tube to enclose the preform primary capillaries and the preform nested capillaries.

Once inserted into the preform cladding tube, the preform arcuate elements, preform primary capillaries, and preform nested capillaries are temporarily fastened through mechanical means to hold them into place. At step 204, the preform components are permanently fused. Methods of fusing include welding processes such as flame welding and laser welding. Welding causes heating, softening, and melting of contacting preform components, which fuse upon cooling to form a fused preform assembly.

In one embodiment, the preform assembly is drawn directly in step 206 to form the anti-resonant hollow-core optical fiber 10. The drawing step 206 includes drawing a hollow-core optical fiber 10 from the preform assembly using a draw system 230 (FIG. 5). The draw system 230 includes a furnace for heating the preform 224 to melt or soften the preform to enable drawing an anti-resonant hollow-core optical fiber 10 through application of tension. Embodiments of preform 224 include the fused preform assembly formed in step 204 and forms thereof that are further processed (see below). The furnace 232 can be disposed in a draw tower. In embodiments, the furnace 232 includes a heater 234 such that the preform 224 is consumed and drawn into the hollow-core optical fiber 10 as it is lowered towards the heater 234. The draw system 230 can further include non-contact measurement sensors 236 for measuring the size (e.g., diameter) of the anti-resonant hollow-core optical fiber 10 that exits the furnace 232. A cooling station 238 can reside downstream of the measurement sensors 236 and is configured to cool the anti-resonant hollow-core optical fiber. A coating station 240 can reside downstream of the cooling station 238. The coating station 240 is configured to deposit a protective coating material 242 onto the anti-resonant hollow-core optical fiber to form a coated anti-resonant hollow-core optical fiber 244. A tensioner 246 resides downstream of the coating station 240. The tensioner 246 has a surface 248 that pulls (draws) the coated anti-resonant hollow-core optical fiber 244. A set of guide wheels 250 with respective surfaces 252 resides downstream of the tensioner 246. The guide wheels 250 serve to guide the coated anti-resonant hollow-core optical fiber 244 to a fiber take-up spool 254 to store the coated hollow-core optical fiber 244.

In one embodiment, processing of the fused preform assembly formed in step 204 includes a redraw step prior to drawing step 206. In the redraw step, the fused preform assembly is heated and redrawn to form a redrawn preform. The redrawn preform has the same internal structure as the fused preform assembly and anti-resonant hollow-core optical fiber 10 with cross-sectional dimensions intermediate between those of the fused preform assembly and anti-resonant hollow-core optical fiber 10. The anti-resonant hollow-core optical fiber 10 is formed from the redrawn preform in drawing step 206 using draw system 230 described above. The redrawn preform is an embodiment of preform 224. A redraw step may be used to control or optimize the dimensions of the preform 224 used in drawing step 206.

In other embodiments, processing of the fused preform assembly formed in step 204 includes adding an overclad to the fused preform assembly (or redrawn preform formed from the fused preform assembly) to form an overclad preform. The overclad is a layer of consolidated glass that surrounds and is directly adjacent to the preform cladding tube in the fused preform assembly. In one embodiment, anti-resonant hollow-core optical fiber 10 is drawn directly in drawing step 206 from the overclad preform. In another embodiment, the overclad preform is redrawn to form a redrawn overclad preform and anti-resonant hollow-core optical fiber 10 is drawn from the redrawn overclad preform in drawing step 206 using draw system 230 described above. The redrawn overclad preform is an embodiment of preform 224.

In one embodiment, formation of the overclad on the preform cladding tube of a fused preform assembly or a redrawn preform occurs by depositing overclad soot on the preform cladding tube and consolidating the overclad soot to form the overclad. Overclad soot consists of glass in a particulate and porous state. Overclad soot can be produced by methods known in the art. Overclad soot is preferably silica soot (or doped or modified silica soot). Suitable methods of soot deposition include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot method, and doped deposited silica processes. A variety of CVD (chemical vapor deposition) and plasma-enhanced CVD processes are known and are suitable for producing silica soot (or doped or modified silica soot).

In another embodiment, formation of the overclad on the preform cladding tube of a fused preform assembly or a redrawn preform occurs by a rod-in-tube method. In the rod-in-tube method, the fused preform assembly or redrawn preform is inserted into an overclad tube and fused thereto to form an overclad preform.

### EXAMPLE

A representative example of an anti-resonant hollow-core optical fiber in accordance with the present disclosure is now described. The design of the anti-resonant hollow-core optical fiber is the design shown in FIG. 2A. Dimensions are summarized in Table 1. Each of the three arcuate elements had the same dimensions and consisted of a circular arc segment. Each of the six primary capillaries had the same dimensions. Each of the six nested capillaries had the same dimensions. Each of the positioning angles 94 and 95 was fixed at 24° for all six primary capillaries. The cladding outer radius was 62.5 μm.

In an actual draw process, merging or recession of the primary capillaries with the cladding tube and of the nested capillaries with the primary capillaries is expected to occur due to softening and the applied draw tension. To simulate this effect, the design include an overlap of 0.2 μm at points of contact between the primary capillaries and the cladding tube, and between the nested capillaries and the primary capillaries.

TABLE 1

Effective core radius = 28.00 μm
Radius of arcuate element = 90.50 μm
Thickness of arcuate element = 0.40 μm
Outer radius of primary capillary = 12.32 μm
Thickness of primary capillary = 0.50 μm
Outer radius of nested capillary = 6.16 μm
Thickness of nested capillary = 0.40 μm

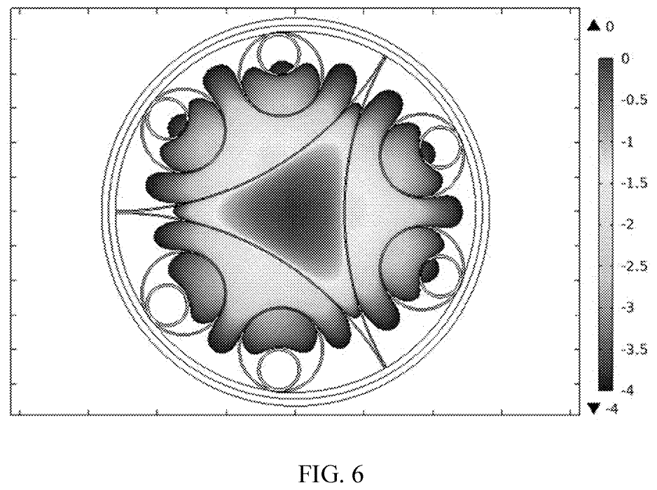

The confinement loss of the fundamental mode and higher order modes as a function of wavelength of electromagnetic radiation transmitted in the effective core region of the design was modeled using COMSOL Multiphysics® finite element software. FIG. 6 shows

FIG. 6 shows the spatial distribution of the electric field of the fundamental mode at 1550 nm in the representative anti-resonant hollow-core optical fiber. A logarithmic relative intensity scale of electric field strength is shown at right. The results indicate a high concentration of the electric field strength of the fundamental mode in the effective core region. The electric field strength at the center of the effective core region was observed to be three-to-four orders of magnitude greater than the electric field strength observed in the primary capillaries and the nested capillaries.

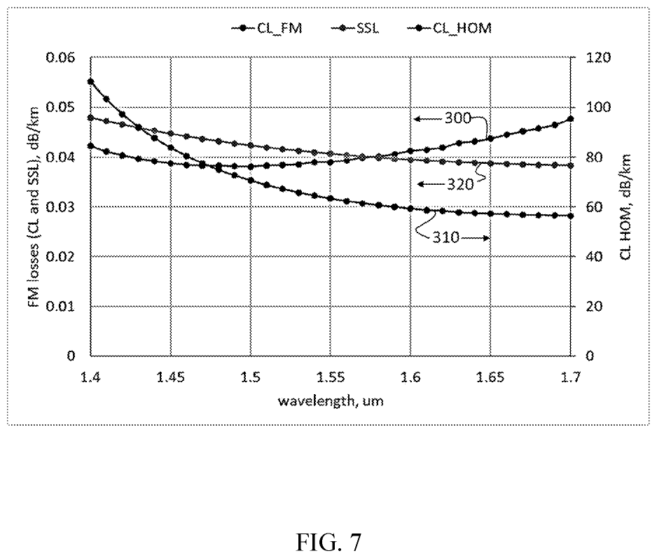

FIG. 7 shows the confinement loss of the fundamental mode (CL_FM) (Trace 300, left scale), confinement loss of the higher order modes (CL_HOM) (Trace 310, right scale), and surface scattering losses (SSL) (Trace 320, left scale) in units of decibels/km (dB/km) over the wavelength range from 1.4 μm to 1.7 μm (1400 nm to 1700 nm). The results show that the confinement loss for the fundamental mode was less than 0.05 dB/km over the entire wavelength range and the confinement loss for the higher order modes was greater than 50 dB/km over the entire wavelength range. The high confinement loss of higher order modes relative to the fundamental mode indicates suitability of the example fiber design for single mode operation.

It will be apparent to those skilled in the art that various modifications and variations can be made without departing from the spirit or scope of the claims.

What is claimed is:

1. An anti-resonant hollow-core optical fiber comprising:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis;
a plurality of arcuate elements extending longitudinally from the first fiber end to the second fiber end, each of the plurality of arcuate elements (a) extending from a first point on the cladding inner surface to a second point on the cladding inner surface, and (b) comprising (i) an arcuate outer surface having an arcuate outer radius facing the fiber longitudinal axis and (ii) an arcuate inner surface facing the cladding inner surface, the arcuate inner surface defining an arcuate interior;
a plurality of first primary capillaries arranged azimuthally around the fiber longitudinal axis, each of the plurality of first primary capillaries (a) contacting the cladding inner surface, (b) disposed within the arcuate interior of a different one of the arcuate elements, and (c) comprising (i) a first primary longitudinal axis that is parallel to the fiber longitudinal axis, (ii) a first primary outer surface at a first primary outer radius from the first primary longitudinal axis, and (iii) a first primary inner surface at a first primary inner radius from the first primary longitudinal axis, the first primary inner surface defining a first primary interior;
a plurality of nested capillaries extending longitudinally from the first fiber end to the second fiber end, each of the plurality of nested capillaries (a) disposed within the first primary interior of a different one of the plurality of first primary capillaries and (b) comprising (i) a capillary axis that is parallel to the fiber longitudinal axis; (ii) a nested outer surface at a nested outer radius from the capillary axis, and (iii) a nested inner surface at a nested inner radius from the capillary axis, the nested inner surface defining a nested interior; and
an effective core region tangential to the arcuate outer surface of the plurality of arcuate elements at an effective core radius from the fiber longitudinal axis, the plurality of arcuate elements disposed radially outward of the effective core region, the effective core region configured to confine electromagnetic radiation.

2. The anti-resonant hollow-core optical fiber of claim 1, wherein the cladding outer radius is greater than or equal to 50 μm.

3. The anti-resonant hollow-core optical fiber of claim 1, wherein the cladding inner radius is greater than or equal to 40 μm.

4. The anti-resonant hollow-core optical fiber of claim 1, wherein the arcuate outer radius of each of the arcuate elements is greater than or equal to 60 μm.

5. The anti-resonant hollow-core optical fiber of claim 1, wherein
each of the plurality of arcuate elements further comprises an arcuate thickness that is within a range of from 250 nm to 1500 nm.

6. The anti-resonant hollow-core optical fiber of claim 1, wherein adjacent ones of the plurality of arcuate elements are in contact at the cladding inner surface.

7. The anti-resonant hollow-core optical fiber of claim 1, wherein the plurality of arcuate elements includes three or more of the arcuate elements.

8. The anti-resonant hollow-core optical fiber of claim 1, wherein
the first primary outer radius of each of the plurality of first primary capillaries is within a range of from 9 μm to 18 μm.

9. The anti-resonant hollow-core optical fiber of claim 1, wherein
each of the plurality of first primary capillaries further comprises a first primary thickness that is within a range of from 250 nm to 1500 nm.

10. The anti-resonant hollow-core optical fiber of claim 1, wherein greater than or equal to one of the plurality of first primary capillaries is disposed in the arcuate interior of each of the plurality of arcuate elements.

11. The anti-resonant hollow-core optical fiber of claim 10, wherein one of the plurality of nested capillaries is disposed in the first primary interior of each of the plurality of first primary capillaries.

12. The anti-resonant hollow-core optical fiber of claim 1, wherein greater than or equal to two of the plurality of first primary capillaries is disposed in the arcuate interior of each of the plurality of arcuate elements.

13. The anti-resonant hollow-core optical fiber of claim 11, wherein the plurality of arcuate elements includes greater than or equal to three of the arcuate elements.

14. The anti-resonant hollow-core optical fiber of claim 1, wherein greater than or equal to three of the plurality of first primary capillaries is disposed in the arcuate interior of each of the plurality of arcuate elements.

15. The anti-resonant hollow-core optical fiber of claim 1,
wherein each of the plurality of first primary capillaries comprises a positioning angle, the positioning angle corresponding to the angle between (a) a radial line that extends orthogonal to the fiber longitudinal axis to bisect the arcuate element defining the arcuate element in which the first primary capillary is disposed and (b) a radial line that extends orthogonal to the fiber longitudinal axis to bisect the first primary capillary, and
wherein the positioning angle is greater than or equal to 10°.

16. The anti-resonant hollow-core optical fiber of claim 1, wherein none of the plurality of primary capillaries contacts another of the plurality of primary capillaries.

17. The anti-resonant hollow-core optical fiber of claim 1, wherein the nested outer radius of each of the nested capillaries is in the range from 5 μm to 10 μm.

18. The anti-resonant hollow-core optical fiber of claim 1, wherein one of the plurality of nested capillaries is disposed in each of the plurality of first primary capillaries.

19. The anti-resonant hollow-core optical fiber of claim 1, wherein
the anti-resonant hollow-core optical fiber exhibits a confinement loss for the fundamental mode of the electromagnetic radiation at each wavelength in a wavelength range from 1400 nm to 1700 nm that is less than or equal to 0.20 dB/km.

20. The anti-resonant hollow-core optical fiber of claim 1, wherein
the anti-resonant hollow-core optical fiber exhibits a confinement loss for the higher order modes of the electromagnetic radiation at each wavelength in a wavelength range from 1400 nm to 1700 nm that is greater than or equal to 10 dB/km.
